(19) United States
(12) Patent Application Publication
(10) Pub. No.: US 2020/0210911 A1
(43) Pub. Date: Jul. 2, 2020

(54) Workflow Management System and Method for Creating and Modifying Workflows

(71) Applicant: Robert Bosch GmbH, Stuttgart (DE)

(72) Inventors: Hyeongsik KIM, San Jose, CA (US); Pongtep ANGKITITRAKUL, Union City, CA (US)

(21) Appl. No.: 16/235,416

(22) Filed: Dec. 28, 2018

(51) Int. Cl. G06Q 10/06

(52) U.S. Cl. CPC G06Q 10/0633; G06Q 10/06311; G06Q 10/06316

(57) ABSTRACT

A workflow management system for generating workflows. The system includes a knowledgebase encoded with terms for steps, dependencies of the steps, and constraints for the steps. The system further includes a computing system programmed to receive the dependencies of the steps from the knowledgebase and to generate a workflow or a portion thereof based on the dependencies of the steps without reference to any other existing workflows.

### TECHNICAL FIELD

The present disclosure relates to workflow management systems and method for creating and modifying workflows.

### BACKGROUND

Workflow management systems are software systems configured to describe and process a sequence of actions, tasks, steps and/or components in many different domains. One such domain is transforming steps and ingredients of a food recipe into a finished product. Another example domain is delivering services, such as repair or replacement of consumer products, such as kitchen appliances. Yet another example of the application of workflow management system technology is in the domain of knowledge and information processing. Several known workflow management systems have been developed. Many of these software systems include intuitive user interfaces for a user to input the actions, tasks, steps and/or components applicable to the user's domain and use case. These systems do not include functionality to automatically generate the content and the sequence of the workflow.

Some workflow management systems have attempted to implement automated planning and scheduling systems into their functionality. Automated planning and scheduling is a form of artificial intelligence that applies strategies typically executed by intelligent agents or autonomous robots. One area of proposed implementation relates to domain independent planning that automatically determines a sequence of actions and/or steps to be performed within a given sequence. This functionality typically relies on the following inputs: (1) a domain-specific model that represents actions and dependencies between the actions in any particular domain; and (2) a problem solution description specifying an initial state and/or goal state.

Knowledgebases have been utilized to store and manage domain-specific information. A knowledgebase is a technology used to store complex structured and unstructured information used by a computer system. Knowledgebases can store a formal definition of entities in domains of interest and relationships between the entities. The entities can be real-world objects, events, situations, or abstract concepts. In many knowledgebases, the entities may be represented by formal structures and standardized terminologies (e.g., controlled vocabularies) configured to permit users and computers to process the structures and terminologies efficiently and unambiguously, and further infer new entities and their relationships.

### SUMMARY

According to one embodiment, a workflow management system for generating workflows is disclosed. The system includes a knowledgebase encoded with terms for steps, dependencies of the steps, and constraints for the steps. The system further includes a computing system programmed to receive the dependencies of the steps from the knowledgebase and to generate a workflow or a portion thereof based on the dependencies of the steps without reference to any other existing workflows.

According to another embodiment, a method for generating workflows is disclosed. The method includes maintaining, by a computing system, a knowledgebase encoded with terms for steps, dependencies of the steps, and constraints for the steps. The method further includes generating, by a computing system, a workflow based on the dependencies of the steps without reference to any other existing workflows.

In another embodiment, a non-transitory computer-readable medium comprising instructions for generating workflows is disclosed. When the instructions are executed by a processor, the processor performs the following operations: maintaining a knowledgebase encoded with terms for steps, dependencies of the steps, and constraints for the steps; and generating a workflow based on the dependencies of the steps without reference to any other existing workflows.

### BRIEF DESCRIPTION OF THE DRAWINGS

FIG. 1 illustrates an example computer system architecture for a workflow management system and method for creating and modifying workflows according to one embodiment.

FIG. 2 illustrates a specific implementation of a computer system architecture for a workflow management system and method according to one embodiment.

FIG. 3 illustrates a process for populating a knowledgebase with organized terms for specific domains according to one embodiment.

FIG. 4 is a schematic diagram that illustrates specific examples of domain knowledgebase relations for a recipe implementation according to one embodiment.

FIG. 5 depicts a schematic diagram of a workflow management process for generating a new workflow according to one embodiment.

FIG. 6 depicts a schematic diagram of a workflow management process for adapting an existing workflow according to one embodiment.

FIG. 7 depicts a schematic diagram of a workflow management process for populating a skeleton workflow with parameters within a knowledgebase according to one embodiment.

FIG. 8 depicts a schematic diagram of a workflow management process for adding parameters to a skeleton workflow according to one embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In known workflow management systems, composing and adapting workflows are tasks that typically require user interfaces that receive input from users. The user interfaces may be configured to define necessary steps and further specify partial or complete orders of the steps. The user interfaces are cumbersome when it comes to adapting existing workflows to reflect changes in requirements or steps. Oftentimes, such an operation requires adding new steps or removing existing steps through a user interface and relinking all relevant steps in the proper order through the user interface.

Moreover, existing workflow management systems lack software functionality to effectively verify whether all the steps in the workflow are properly connected without violating any dependencies and forming workflows that semantically make sense. Without a software solution for this functionality, verifications are often difficult, if not impossible, due to the necessity to track all possible combinations of connections, which often complicated and numerous in complex workflows.

Furthermore, existing workflow management systems lack software functionality to effectively maintain adapted workflows between different users. Without a software solution for this functionality, when different groups of users with different backgrounds or users who may not have sufficient domain knowledge to maintain or adapt the workflow, discontinuities and break downs in the adapted workflows may develop because of disparate understandings of what steps are needed or how the steps should be linked or sequenced. One proposed solution is to integrate a knowledgebase feature configured to determine expert comments added using natural language to enhance understanding of adapted workflows across different users. However, maintaining such a feature for every workflow step and connections between the steps may consume a significant amount of user time.

Meanwhile, automated planning systems have been used in certain domains. However, these computer systems typically offer limited user interface functionality because the systems are more geared towards implementing and testing computer optimized algorithms that effectively construct plans in an automated fashion. These systems often require input from domain experts to specify and verify inputs, e.g., defining all terms with dependencies using customized languages such as planning domain definition language (PDDL) or general computing programming languages. In addition, often different names and structures of the terms are used for the description of the same domain or the same problem, making it challenging to re-use them later for different purposes or by different systems. Furthermore, the description of the domain and the problem are typically stored and managed using flat text files instead of using advanced data management programs such as database or knowledgebases that require standardized terms or structures.

Moreover, the following proposed computer systems and computerized methods have failed to provide adequate technical solutions.

Kim, Jihie, Yolanda Gil, and Marc Spraragen. “A knowledge-based approach to interactive workflow composition.” 14th International Conference on Automatic Planning and Scheduling (ICAPS 04). 2004, and Kim, Jihie, and Yolanda Gil, “Knowledge analysis on process models.” Proceedings of the 17th International Joint Conference on Artificial Intelligence. 2001 disclose an interactive workflow composition system configured to assist users in selecting and configured steps in workflows. The interactive workflow composition system uses formalized terms stored in knowledgebases. However, these systems do not generate a workflow based on the dependencies of steps encoded into a knowledgebase so that workflows can be automatically created or pre-existing workflows can be automatically reorganized.

Myers, Karen L., et al. “PASSAT: A user-centric planning framework.” Proceedings of the 3rd International NASA Workshop on Planning and Scheduling for Space. 2002 discloses a computer system that creates plan sketches from domain knowledge. The system is configured to detect errors caused by extra steps and/or violated conditions in the initial sketches. Doshi, Prashant, et al. “Dynamic workflow composition: Using markov decision processes.” International Journal of Web Services Research (IJWSR) 2.1 (2005): 1-17 discloses the use of statistical methods such as Markov decision processes to handle uncertain changes in a real-world scenario. Dang, Jiangbo, et al. “An ontological knowledge framework for adaptive medical workflow.” Journal of biomedical informatics 41.5 (2008): 829-836 discloses a system that employs ontologies and knowledgebases specific to the medical domain. However, none of these systems generate a workflow based on the dependencies of steps encoded into a knowledgebase so that workflows can be automatically created or pre-existing workflows can be automatically reorganized, or incrementally, step-by-step, generating proposed steps of the new workflow based on the dependencies of the steps.

The Kim and Myers systems and methods do not provide suggestions for adding new steps or adapting existing workflows while the workflow is being created or adapted. Rather, these systems follow a draft-first, fix-later strategy in which the user is responsible for adding new steps or adapting existing steps when using the systems and methods. With these systems and methods, once a user is finished adding new steps or modifying existing steps, these systems and methods inform the user of potential problems of the selections made by the user, similar to a compiling and debugging process for software code.

In one or more embodiments of the present disclosure, systems and methods are disclosed that deploy an active strategy that guides users to select the correct steps while the workflow is being created or adapted. For instance, when users need to add or modify steps, the systems and methods suggest a number of possible, correct steps using dependencies and constraints stored in a knowledgebase. In this way, the systems and methods prevent a user from selecting steps that are improper (and later need to be changes through a different process). When existing workflows replace steps with other steps, the systems and methods present through a user interface a number of possible, correct workflows for selection, thereby avoiding the necessity to verify correctness of the workflows later and correcting mistakes.

US 2004/0103014 discloses a system that creates new workflows by directly referring to and adjusting actions in the existing, saved workflows by multiple users. The system then uses limitations imposed by a separate constraints system that uses information stored in knowledgebases. The disclosed system requires existing, saved workflows. This system does not use a knowledgebase curated by a domain expert in advance of the creation or adaptation of a workflow. As disclosed in one or more embodiments, the workflow management system is configured to compose entirely new workflows or revise existing ones without references to any stored workflows.

US 2011/0113008 discloses a system for automating office workflows by providing customization, including name of system, task-names, role names, names of actions on each task, order of tasks, etc., using web interfaces and ASP.net language. This system is configured to provide pre-defined forms or templates for users who are primarily responsible for completing the form or the template without assistance from the system. This system does not generate a workflow based on the dependencies of steps encoded into a knowledgebase so that workflows can be automatically created or pre-existing workflows can be automatically reorganized, or incrementally, step-by-step, generating proposed steps of the new workflows based on the dependencies of the steps.

The workflow management computer system, computer-readable medium and knowledgebase structural component aspects disclosed herein provide a non-abstract, technological improvement over the known proposals. These technological improvements are rooted in a domain encoded knowledgebase structure that is encoded with domain information. The domain information is logically categorized such that it can be used to generate new workflows and adapted workflows.

The workflow management computer system, computer-readable medium and knowledgebase structural component aspects disclosed herein include a particular arrangement of generic and conventional computer components to provide a method and system for workflow management for generating new workflows and adapted workflows. In one or more examples, the present invention provides a non-conventional and non-generic arrangement of computer components. The structure of the domain knowledgebase is not disclosed or suggested by the prior art as disclosed herein. For example, the domain knowledgebase structure includes dependencies of standardized steps that can be used to generate new workflows and adapted workflows.

In one or more examples, the workflow management systems set forth herein provide significantly more than a generic way to generate new workflows and adapted workflows from existing workflows.

The domain knowledgebase structure is inextricably tied to a machine for generating new workflows and adapted workflows from existing workflows. The exemplar aspects do more than a nominal recitation of a computer.

Aspects herein relate to tangible devices, e.g., workflow management computer system, workflow computer readable medium, and domain knowledgebase structural components. The devices operate in an environment of workflows, e.g., recipes. The tangible devices and workflows work in combination to provide a specific manner of providing computer tools and structures for generating new workflows and adapted workflows from existing workflows.

In light of the foregoing, a workflow management system and method for creating and modifying workflows are disclosed herein. The workflow management system may automatically create and modify workflows. One or more embodiments integrate automated planners and knowledgebases into a workflow management system such that the integrated system is configured to employ standardized terminologies for workflows. The workflow management system may be further configured to compose or revise a workflow based on inputs or hints from a user.

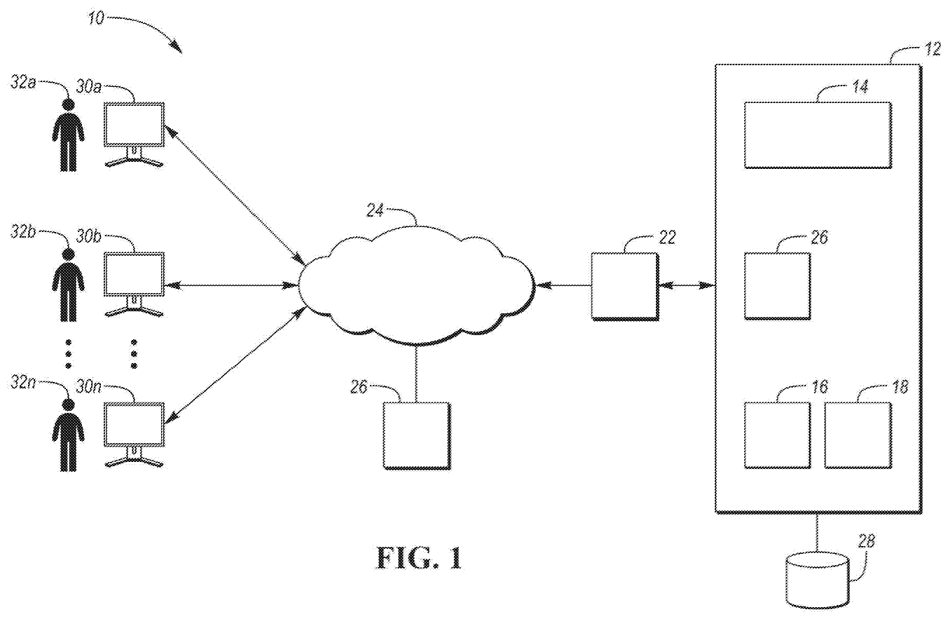

FIG. 1 illustrates computer system 10 for a workflow management system and method. Computing system 10 may be configured to create and modify workflows according to one or more embodiments. Computing system 10 includes server 12. Server 12 may include at least one microprocessor unit 14. Server 12 may also include volatile memory 16 and non-volatile memory 18 for storing instructions and data. Memory 16 and/or 18 may store and maintain computer-executable instructions, where the instructions may be executed by microprocessor unit 14. Such instructions and other data may be stored using a variety of computer-readable medium. The computer-readable medium (also referred to as a processor-readable medium or storage) includes any non-transitory (e.g., tangible) medium that participates in providing data (e.g., instructions) that may be read by a computer (e.g., by microprocessor unit 14). In general, processors receive instructions, e.g., from the memory via the computer-readable storage medium, etc., and executes these instructions, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C #, Fortran, Pascal, Visual Basic, Java Script, Perl, PL/SQL, etc. In one embodiment, the computer-executable instructions are compiled or interpreted from computer programs created in C #, .Net, Service Stack, SQL, PHP (for Linux) and/or ASP .Net (for Windows) and Rest API.

Server 12 may further include network interface 20 that is configured to provide communication with network router 22. For example, network router 22 may be a wired or wireless Ethernet router. In some configurations, network router 22 may be further configured to provide a communication interface to external network 24. In some configurations, computing system 10 may exist as a remote server in a cloud computing architecture and may be referred to as a “cloud solution.” In other configurations, computing system 10 may exist in a hosted environment where server 12 is local to users, e.g., without the use of external network 24, and may be referred to as a “hosted solution.”

External network 24 may be referred to as the world-wide web or the Internet. External network 24 may establish a standard communication protocol between computing devices. External network 24 may permit information and data to be easily exchanged between computing devices and networks. At least one server(s) 26 may host a website or webpage from which information may be derived. For example, server 26 may host a webpage that has information relevant to a domain of interest. Server(s) 26 may host one or more unstructured data sources that provide data in varying formats including a blog, a forum, an article, images, audio, and/or videos. The data may be considered unstructured as there may be no common format between the sources. For example, each website may be arranged differently. Domain-relevant information may be repeated on different webpages/web sites.

Servers 12 and 26 may include various types of computing apparatus, such as a computer workstation, a server, a desktop computer, a virtual server instance executed by a cluster or group of dedicated servers or computers, or some other computing system and/or device.

Computing system 10 may be configured to build, modify, adapt and/or generate knowledgebase 28. Knowledgebase 28 may include instructions that, when loaded into memory and executed by the server 12 cause the knowledgebase 28 to perform database functionality including the storage, update, and retrieval of relational information. Databases or data repositories such as the knowledgebase 28 may include various kinds of mechanisms for storing, accessing, and retrieving various kinds of data, including a hierarchical database, a set of files in a file system, an application database in a proprietary format, a relational database management system (RDBMS), etc. In one embodiment, knowledgebase 28 is a relational database in Microsoft SQL Server. The knowledgebase 28 may employ features of the computer operating system of the server 26. Knowledgebase 28 may also utilize the file system via the computer operating system and may store and retrieve files stored in various formats. An RDBMS generally employs the Structured Query Language (SQL) in addition to a language for creating, storing, editing, and executing stored procedures.

Computer system 10 further includes workstations 30a, 30b through 30n configured to permit users 32a, 32b through 32n access to external network 24, servers 12 and 26 and knowledgebase 28. Workstations 30 may be personal computing devices, each including a user interface for input and output. For example, workstations 30 may be computers having a display and keyboard. Workstations 30 may also include tablets and cell phones.

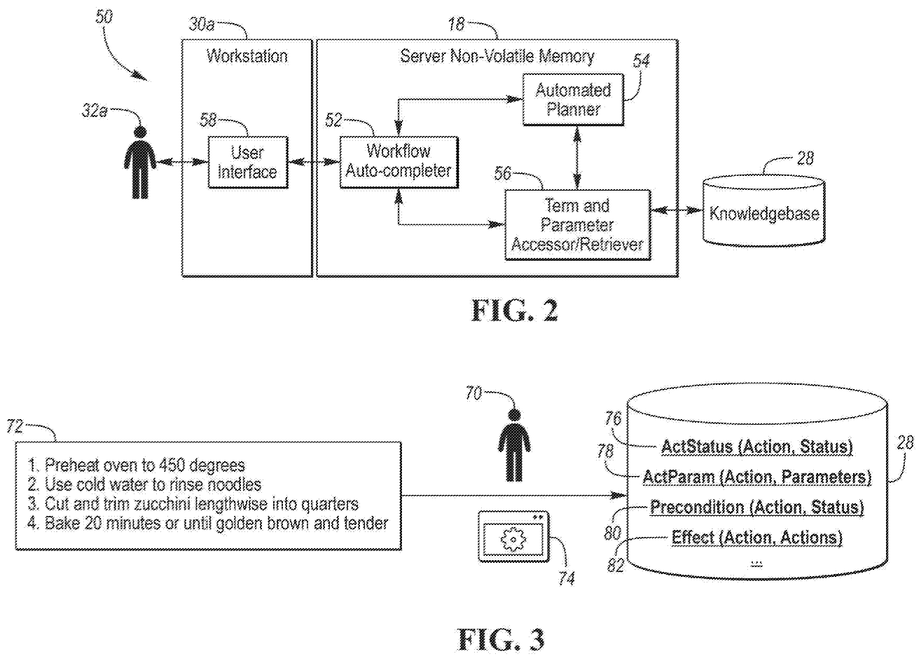

FIG. 2 illustrates specific implementation 50 of a computer system architecture for a workflow management system and method according to one embodiment. In specific implementation 50, non-volatile memory 18 of server 12 is configured to store workflow auto-completer module 52, automated planner module 54 and term and parameter accessor/retriever module 56. In specific implementation 50, workstation 30a includes user interface 58 configured for user 32a to access modules 52, 54 and 56 and other components of computing system 10. Workflow auto-completer module 52 and user interface 58 are in direct communication with each other. Workflow auto-completer module 52 and automated planner module 54 are in direct communication with each other. Workflow auto-completer module 52 and term and parameter accessor/retriever module 56 are in direct communication with each other. Automated planner module 54 and term and parameter accessor/retriever module 56 are in direct communication with each other. Term and parameter accessor/retriever 56 and domain knowledgebase 28 are in direct communication with each other.

Knowledgebase 28 is configured and structured to permit standardization and organization of terms which are commonly used in specific domains into knowledgebases stored in knowledgebase 28. FIG. 3 illustrates a process for populating knowledgebase 28 with organized terms for specific domains according to one embodiment. Domain expert 70 may collect workflow descriptions into formalized terms and their parameters for storage in knowledgebase 28. In one or more embodiments, the workflow descriptors may denote media such as unstructured text descriptions, video images, or audio recording that describe workflows for any domain. For instance, the workflow descriptors may be a recipe in a cooking domain or maintenance instructions in an automotive domain. As shown in FIG. 3, text workflow descriptions 72 relating to a recipe are shown. The text workflow descriptions 72 are: (1) preheat oven to 450 degrees; (2) use cold water to rinse noodles; (3) cut and trim zucchini lengthwise into quarters; and (4) bake 20 minutes or until golden brown and tender. Conversion program 74 may be used to convert workflow descriptions into formalized terms and their parameters for storage in knowledgebase 28.

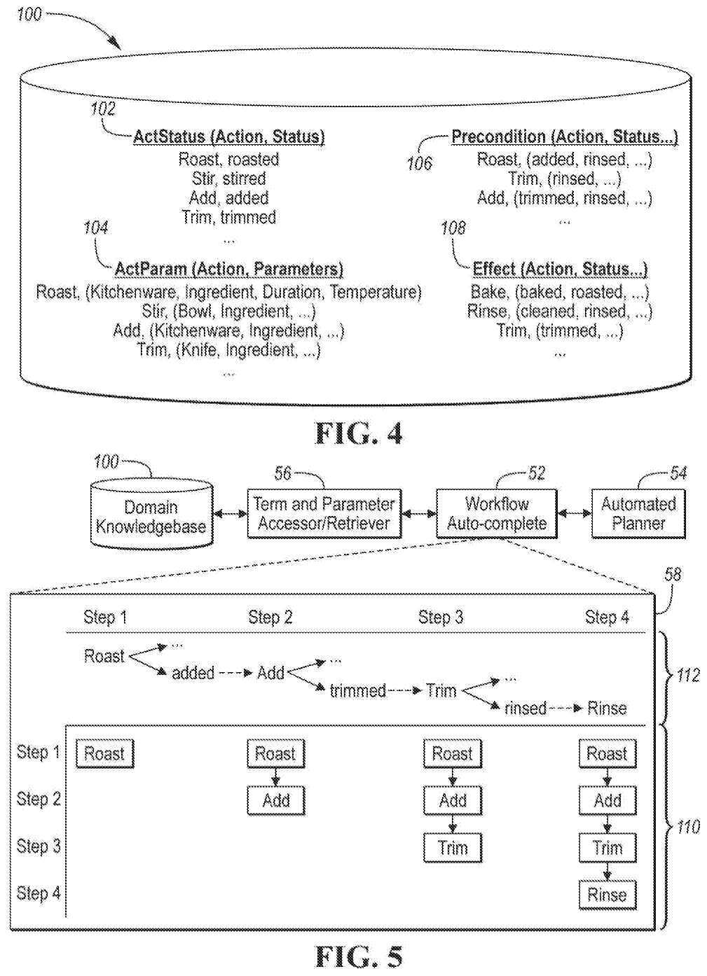

FIG. 3 also illustrates a number of relations which can used to store formalized terms and their relations in knowledgebase 28. FIG. 4 is a schematic diagram of knowledgebase 100 that illustrates specific examples of these relations for a recipe implementation according to one embodiment. The number of relations may include ActStatus 76, ActParam 78, Precondition 80 and Effect 82.

The relation ActStatus 76 may contain a mapping record (Action, Status) between a term for a step and a term for a status. For example, FIG. 4 shows several examples of ActStatus mapping records 102 for a recipe. For instance, the first mapping record is (Roast, roasted), which denotes that by applying a roast step to certain ingredients causes those ingredients to reach the status of roasted. Other mapping records depicted on FIG. 4 for the ActStatus relation include (Stir, stirred), (Add, added) and (Trim, trimmed).

The relation ActParam 78 may contain a mapping record (Action, (Parameter(s))) between a term for a step and term(s) for the parameter(s) for the step. For example, FIG. 4 shows several examples of ActParam mapping records 104 for a recipe. For instance, the first mapping record is (Roast, (Kitchenware, Ingredient, Duration, Temperature)), which represents the step “Roast” and four parameterized terms to describe the step with clarity. In one or more embodiments, the step “Roast” requires specification of what types of kitchenware should be used, what kinds of ingredients should be used, and how long ingredients should be roasted under a certain temperature. Other mapping records depicted on FIG. 4 for the ActParam relation include (Stir, (Bowl Ingredient, . . . ), (Add, (Kitchenware, Ingredient, . . . ), and (Trim, (Knife, Ingredient, . . . ).

The relation Precondition 80 may contain a mapping record (Action, (Status . . . )) between a term for an action and term(s) for the precondition(s) for the action. For example, FIG. 4 shows several examples of Precondition mapping records 106 for a recipe. For instance, the first mapping record is (Roast, (added, rinsed, . . . ), which denotes that, to roast certain ingredients, the current status of the workflow need to have reaches “added” and “rinsed.” This mapping record encodes knowledge of a cooking domain that certain ingredients need to be “rinsed” and “added” in some kitchenware vessel before the ingredients are roasted. Other mapping records depicted on FIG. 4 for the Precondition relation include (Trim, (rinsed, . . . ) and (Add, (trimmed, rinsed, . . . ).

The relation Effect 82 may contain a mapping record (Action, (Status . . . )) between a term for an action and term(s) for the effect(s) of the action. For example, FIG. 4 shows several examples of Effect mapping records 108 for a recipe. For instance, the first mapping record is (Bake, (baked, roasted, . . . ), which denotes that baking some ingredients leads to the status “baked” and/or “roasted.” This mapping record encodes knowledge of a cooking domain that certain ingredients reach a status of “baked” and/or “roasted” upon carrying out the baking action. Other mapping records depicted on FIG. 4 for the Effect relation include (Rinse, (cleaned, rinsed, . . . ) and (Trim, (trimmed, . . . )).

The ActStatus, ActParam, Precondition and Effect relations are exemplary of certain embodiments. Other approaches or database schema configured to represent knowledge can be utilized. For example, graph databases may be employed where terms are expressed as nodes and relationships between nodes may be expressed as edges. In this example, mappings can be encoded in forms of subgraphs, e.g., nodes can be terms for steps and edges can be linked over nodes to represent dependencies among actions.

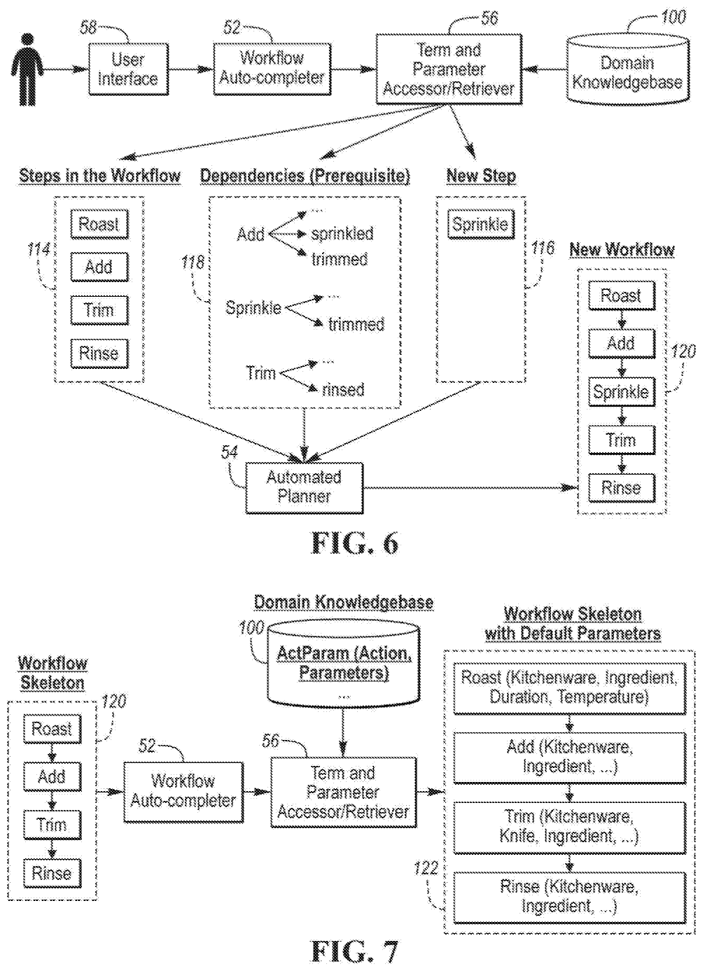

Workflow auto-completer module 52 of non-volatile memory 18 of server 12 is configured to generate candidate sub-workflows used in a generation of a new workflow or an adaptation of an existing workflow. FIG. 5 depicts a schematic diagram of a workflow management process for generating a new workflow according to one embodiment. FIG. 6 depicts a schematic diagram of a workflow management process for adapting an existing workflow according to one embodiment.

Referring to FIG. 5, workflow auto-completer module 52 accesses knowledgebase 100 via term and parameter accessor/retriever module 56. Auto-completer module 52 is configured to transmit one or more action terms to term and parameter accessor/retriever module 56. Term and parameter accessor/retriever module 56 is configured to obtain relation mapping records from knowledgebase 100 based on the one or more action terms passed from workflow auto-completer module 52. Parameter accessor/retriever module 56 transmits the mapping records to workflow auto-completer module 52, which is configured to display at least a portion of one or more of relation mapping records on user interface 58.

FIG. 5 depicts an example of the functionality of workflow auto-completer 52 for displaying at least a portion of one or more of relation mapping records on user interface 58. In step 1, the action term “Roast” is selected and a request is made to determine the steps necessary before the “roasting” action. Workflow auto-completer 52 is configured to transmit the request to term and parameter accessor/retriever module 56, which is configured to process the request by querying precondition mapping records 106 residing in knowledgebase 100 that match the request. As shown in FIG. 4, precondition mapping record (Roast, (added, rinsed, . . . ) matches the request. Parameter accessor/retriever module 56 transmits this record to workflow auto-completer 52, which is configured to display one or more status(es) associated with the record through user interface 58. As shown on FIG. 5, the status “added” is displayed in upper region 112 of user interface 58. “Added” is further linked to the action term “add,” which also has a precondition record in knowledgebase 100. Once “added” is selected by the user, “add” is added to workflow 110 under “roast.” Also, after this selection is made, computer system 10 incrementally retrieves any relevant precondition mapping records 106 associated with the action term “add.” In this example, precondition mapping record (Add, (trimmed, rinsed, . . . ) matches the action term “add”. As shown on FIG. 5, the status “trimmed” is displayed in upper region 112 of user interface 58. “Trimmed” is further linked to the action term “trim,” which also has a precondition record in knowledgebase 100. Once “trimmed” is selected by the user, “trim” is added to workflow 110 under “add.” Also, after this selection is made, computer system 10 incrementally retrieves any relevant precondition mapping records 106 associated with the action term “trim.” In this example, precondition mapping record (Trim, (rinsed, . . . ) matches the action term “trim.” As shown on FIG. 5, the status “rinsed” is displayed in upper region 112 of user interface 58. Once “rinsed” is selected by the user, “rinse” is added to workflow 112 under “trim.” In this embodiment, this incremental, step-by-step auto-complete process may be repeated until no possible steps exist or the process is halted, e.g, by the user.

Accordingly, in this embodiment, computer system 10 determines steps that should be performed before the initial step selected by the user. In this way, system 10 is configured to determine and display possible connected steps in a step-by-step incremental manner. Computer system 10 is configured to receive input from users in an incremental manner to choose appropriate terms based on determinations made by computer system 10. Computer system 10 is thereby configured to build workflow 110 in a backward manner (e.g., last step to first step in a stepwise manner). Workflow 110 may be referred to as a skeleton workflow because each step of workflow 110 only includes each key term that describes its step without any further details regarding the step. In other embodiments, computer system 10 is configured to couple key terms with parameters and meta-data to obtain a workflow with greater details.

FIG. 6 depicts an example of the functionality of workflow auto-completer module 52 and term and parameter accessor/retriever module 56 for determining steps in relation to adapting (e.g., adding new steps, removing existing steps or revising existing steps) existing workflow 114. In this example, workflow auto-completer module 52 is configured to receive one or more terms for actions from existing workflow 114. Workflow auto-completer module 52 is configured to transmit these terms to parameter accessor/retriever module 56, which is configured to determine if the action terms are stored in domain knowledgebase 100 by accessing domain knowledgebase 100 via a suitable driver such as Java Database Connectivity (JDBC) or Open Database Connectivity (ODBC). Term and parameter accessor/retriever module 56 is configured to receive input to add action terms and relations to domain knowledgebase 100 if such terms and relations do not exist in knowledgebase 100.

Once term and parameter accessor/retriever module 56 determines that the action terms are stored in domain knowledgebase 100, term and parameter accessor/retriever module 56 transmits the following data to automated planner module 54: (1) the action terms in existing workflow 114, (2) the action terms that will be adapted, e.g., a new step 116 (“Sprinkle”), and (3) the states of each action term to be adapted with each state's dependencies, e.g., dependencies 118. Knowledgebase 100 is pre-encoded with dependencies for “sprinkle,” e.g., a precondition states for “add” is updated with “sprinkled” and “trimmed” such that the new step “sprinkle” happens before the existing step “add.” In this example, the pre-encoding is based on the recognition that sprinkling some ingredients such as olive oil should be done before adding any ingredients into kitchenware such as ovens.

Automated planner module 54 is configured to re-organize existing workflow 114 based on the encoded dependencies 118. For instance, the new step “sprinkle” is added between “add” and “trim” to generate new workflow 120. In another embodiment, multiple new workflows may be generated by automated planner module 154 where there are no specific dependencies among steps, e.g., “drizzle” and “sprinkle” may be exchanged because the terms may have a similar meaning. In the cases where multiple new workflows are generated, automated planner module 54 may be configured to format the multiple new workflows for display on user interface 58 so that a selection can be made between the multiple new workflows.

FIG. 7 depicts a schematic diagram of a workflow management process for populating a skeleton workflow with parameters within a knowledgebase according to one embodiment. Workflow auto-completer module 52 is configured to receive workflow skeleton 120. Workflow auto-completer module 52 is configured to pass the steps in workflow skeleton 120 to term and parameter accessor/retriever module 56. Term and parameter accessor/retriever module 56 is configured to receive ActParam mapping records 104 from knowledgebase 100. Term and parameter accessor/retriever module 56 is configured to populate workflow skeleton 120 with parameters from ActParam mapping records 104 based on the terms of workflow skeleton 120 and the parameters within ActParam mapping records 100 to obtain a workflow skeleton with default parameters 122. For instance, term and parameter accessor/retriever module 56 can link step “roast” with four default parameters based on the associated ActParam mapping records 100. The four default parameters may be kitchenware that can be used for roasting such as ovens, ingredients to be roasted such as zucchini or chicken, the duration that needs to be maintained for roasting, and finally temperature that needs to be specified for roasting.

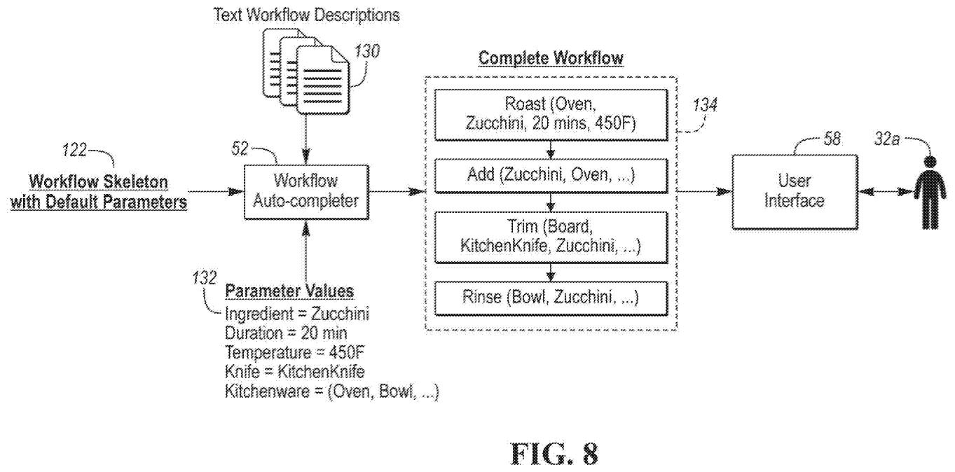

FIG. 8 depicts a schematic diagram of a workflow management process for adding parameters to a skeleton workflow according to one embodiment. Workflow auto-completer module 52 is configured to receive text workflow descriptions 130, a workflow skeleton with default parameters 122, and parameter values 132. Workflow auto-completer module 52 is configured to generate a complete workflow 134 based on text workflow descriptions 130, a workflow skeleton with default parameters 122, and parameter values 132. Workflow auto-completer module 52 is configured to utilize natural language processing (NLP) techniques such as slot-filling to obtain parameters from text workflow descriptions 130. Workflow auto-completer module 52 may also receive user input of one or more parameters, e.g., parameter “ingredient” as “zucchini,” and “duration” as “20 min.” Workflow auto-completer module 52 is configured to access ActParam mapping records to populate each action step with the parameter values determined or obtained by workflow auto-completer module 52. For instance, if the ActParam mapping record is (Roast, (Kitchenware, Ingredient, Duration, Temperature)) and the parameter values are “oven”, “zucchini”, “20 mins” and “450 F”, then the complete workflow for the roast step is Roast (Oven, Zucchini, 20 mins, 450 F), as depicted in the complete workflow 134 of FIG. 8. Once the parameters are completed by workflow auto-completer module 52, workflow auto-completer module 52 is configured to transmit complete workflow 134 to user interface 58, such as a verbalizer device. The verbalizer device may be configured to transform standardized terms for actions and parameters into natural language sentences.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A workflow management system for generating workflows comprising:
a knowledgebase encoded with terms for steps, dependencies of the steps, and constraints for the steps; and
a computing system programmed to receive the dependencies of the steps from the knowledgebase and to generate a workflow or a portion thereof based on the dependencies of the steps without reference to any other existing workflows.

2. The workflow management system of claim 1, wherein the knowledgebase is further encoded with parameters used to describe the steps.

3. The workflow management system of claim 1, wherein the workflow is a new workflow.

4. The workflow management system of claim 3, wherein the computing system is programmed to incrementally, step-by-step, generate proposed steps of the new workflow based on the dependencies of the steps.

5. The workflow management system of claim 1, wherein the workflow is an adapted, existing workflow.

6. The workflow management system of claim 1, further comprising a conversion program programmed to receive workflow description information and to convert the workflow description information into the terms for the steps.

7. The workflow management system of claim 6, wherein the conversion program is further configured to convert the workflow description information into the dependencies of the steps.

8. The workflow management system of claim 6, wherein the conversion program is further configured to convert the workflow description information into the constraints of the steps.

9. The workflow management system of claim 6, wherein the computing system is further configured to encode the terms for the steps converted by the conversion program into the knowledgebase.

10. A method for generated workflows comprising:
by a computing system,
maintaining a knowledgebase encoded with terms for steps, dependencies of the steps, and constraints for the steps; and
generating a workflow based on the dependencies of the steps without reference to any other existing workflows.

11. The method of claim 10, further comprising encoding the knowledgebase with parameters used to describe the steps.

12. The method of claim 10, wherein the workflow is a new workflow.

13. The method of claim 12, further comprising incrementally, step-by-step, generating proposed steps of the new workflow based on the dependencies of the steps.

14. The method of claim 10, wherein the workflow is an adapted, existing workflow.

15. The method of claim 10, converting workflow description information into the terms for the steps encoded into the knowledgebase.

16. A non-transitory computer-readable medium comprising instructions for generating workflows that, when executed by a processor, cause the processor to perform the following operations:
maintaining a knowledgebase encoded with terms for steps, dependencies of the steps, and constraints for the steps; and
generating a workflow based on the dependencies of the steps without reference to any other existing workflows.

17. The medium of claim 16, wherein the instructions are further configured to encode the knowledgebase with parameters used to describe the steps.

18. The medium of claim 16, wherein the workflow is a new workflow.

19. The medium of claim 18, wherein the instructions are further configured to incrementally, step-by-step, generate proposed steps of the new workflow based on the dependencies of the steps.

20. The medium of claim 16, wherein the workflow is an adapted, existing workflow.
